(19) United States
(12) Patent Application Publication
(10) Pub. No.: US 2026/0014630 A1
(43) Pub. Date: Jan. 15, 2026

(54) PLUNGE SPEED CONTROL FOR AUTOMATED SAW SYSTEM

(71) Applicant: MITEK HOLDINGS, INC., Wilmington, DE (US)

(72) Inventors: Daniel Brames, Chesterfield, MO (US); Andrew Stevens, St. Peters, MO (US); Anthony Anderson, Williamsburg, MO (US)

(21) Appl. No.: 19/246,860

(22) Filed: Jun. 24, 2025

Related U.S. Application Data
(60) Provisional application No. 63/670,482, filed on Jul. 12, 2024.

(51) Int. Cl. B23D 59/00

(52) U.S. Cl. CPC B23D 59/001; B23D 59/008

(57) ABSTRACT

A saw system and method of cutting material. The saw system includes a saw having a saw blade configured to plunge into the material during the cutting. A controller controls operation of the saw. The controller has a memory storing processor-executable instructions that, when executed, configure the controller for receiving one or more parameters of the material to be cut, and determining a cut profile length as a function of the received one or more parameters. A rate at which the saw blade plunges into the material to be cut is dynamically adjusted based on the determined cut profile length.

### CROSS-REFERENCE TO RELATED APPLICATION

This application claims priority to U.S. Provisional Application No. 63/670,482, filed July 12, 2024, the entirety of which is incorporated by reference.

### BACKGROUND

Commercial saws used for cutting lumber and other materials operate without user input in normal production operation. The rate at which the blade is advanced into the material being cut (i.e., the "plunge speed") will have a substantial effect on the quality of the cut and the rate of wear of the blade and other components of the saw.

### SUMMARY

In one aspect, a dynamically adjustable automated saw system constructed according to the principles of the present invention generally comprises a saw for automated cutting of material. The saw has a saw blade configured to plunge into the material during the cutting and a controller in communication with the saw for controlling operation of the saw. A memory stores processor-executable instructions that, when executed, configure the controller for receiving one or more parameters of the material to be cut, and determining a cut profile length as a function of the received one or more parameters. A rate at which the saw blade plunges into the material to be cut is dynamically adjusted by the controller based on the determined cut profile length.

In another aspect of the present invention is a method of automated cutting of material generally comprising receiving one or more parameters of a material to be cut by a saw blade which is configured to plunge into the material during cutting. Processor-executable instructions are executed to determine a cut profile length of the material to be cut as a function of the received one or more parameters. The saw blade is plunged into the material during cutting. A rate at which the saw blade plunges into the material to be cut is adjusted based on the determined cut profile length.

Other objects and features of the present invention will be in part apparent and in part pointed out hereinafter.

### DESCRIPTION OF THE DRAWINGS

FIG. 1 is a perspective of a saw system;

FIG. 2 is an enlarged, fragmentary perspective of the saw system with parts of a saw unit removed to show internal construction of the saw;

FIG. 3 is an enlarged, fragmentary perspective of the saw system with further parts removed to show the saw blade;

FIG. 4 is a perspective of the saw system as shown in FIG. 3, but from a top side vantage;

FIG. 5 is a further enlarged, fragmentary perspective of the saw system with parts of the saw unit removed to show internal construction;

FIG. 6 is the perspective of FIG. 5, but from a bottom vantage with parts of the saw unit removed to show internal construction;

FIG. 7 is a schematic illustration of a controller and operating components of the saw system;

FIG. 8 is a simplified flow chart showing determination of maximum torque value for of a turntable of the saw unit;

FIG. 9 is a simplified flow chart showing calibration of the turntable;

FIG. 10 is a simplified flow chart showing determination of maximum torque value for a pusher bar for the saw unit;

FIG. 11 is a simplified flow chart showing calibration of the pusher bar; and

FIG. 12 is a flow chart illustrating determination of cut profile length for establishing plunge speed.

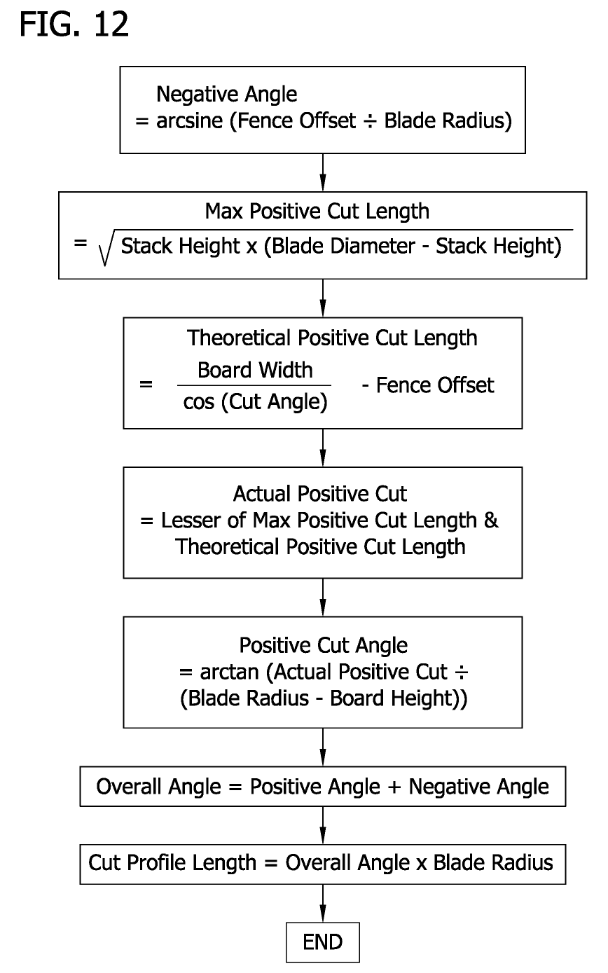

Corresponding reference characters indicate corresponding parts throughout the several views of the drawings.

### DESCRIPTION

Referring now to the drawings, a saw system 10 is shown to include an infeed conveyor 12, a saw unit 14 and an outfeed conveyor 16. Boards (not shown) are loaded into the infeed conveyor 12 manually or automatically. The infeed conveyor 12 fees the boards to the saw unit 14 where the boards are cut to length and at angles to facilitate interconnection. The boards can be fed one at a time or as groups of two or more to the saw unit 14. The cut boards can also be imprinted with information regarding the boards (i.e., their position in an assembled item) in

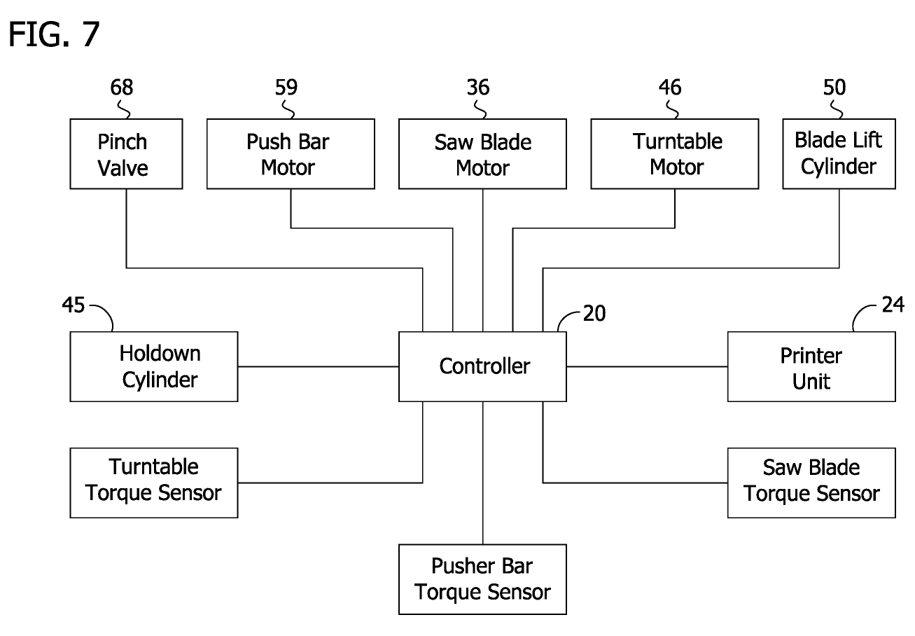

the saw unit 14. Boards are discharged from the saw unit 14 to the outfeed conveyor 16. In the illustrated embodiment, the infeed conveyor 12 includes a lateral feeder 18 that can hold boards for feeding onto the main portion of the infeed conveyor. In one, non-limiting embodiment, the saw system 10 can be configured to automatically cut all of the components needed to make a wall frame for a building. The information for making a wall frame can be downloaded onto a controller 20 (FIG. 7) for the saw system 10 from design software used to design the building (e.g., a residence).

The saw system 10 further includes a monitor station 22 for holding a monitor that provides the operator with information regarding the functioning and operation of the saw system. The operator may also provide input to the controller 20 from the monitor at the monitor station 22. Immediately upstream form the saw unit 14 is a printer unit 24. The printer unit includes a printer 26 and hold down rollers 28. The printer unit 24 can be lowered from the position shown in the drawings down into engagement with one of the boards. The rollers 28 press the board down flat and hold it for application of printing to the board without requiring motion of the board to the stopped.

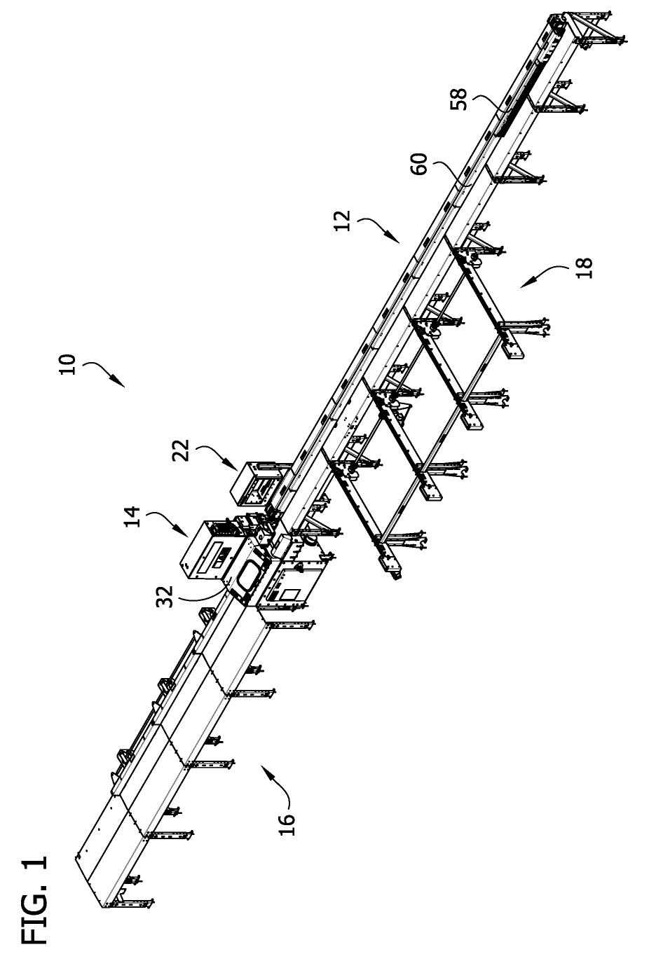

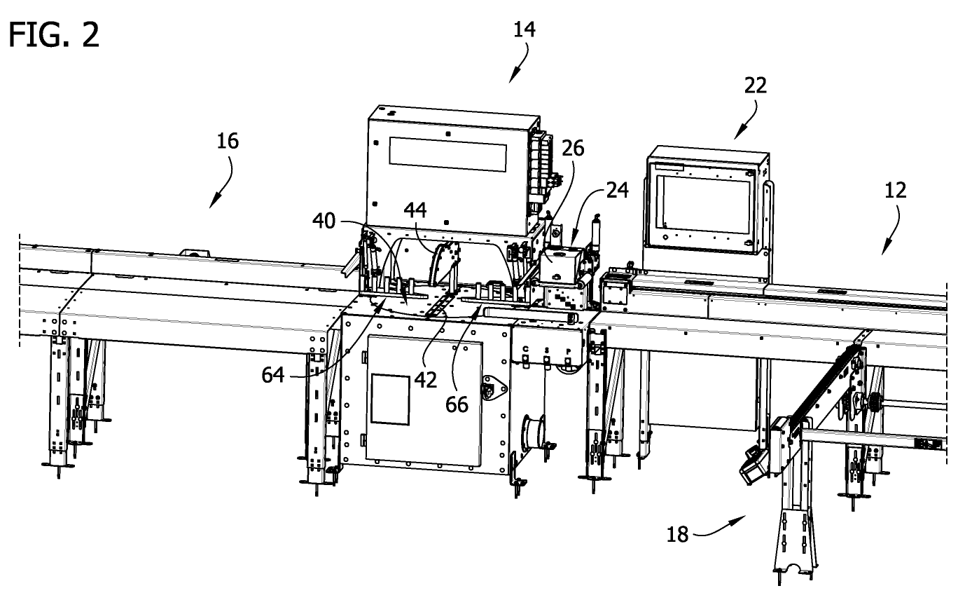

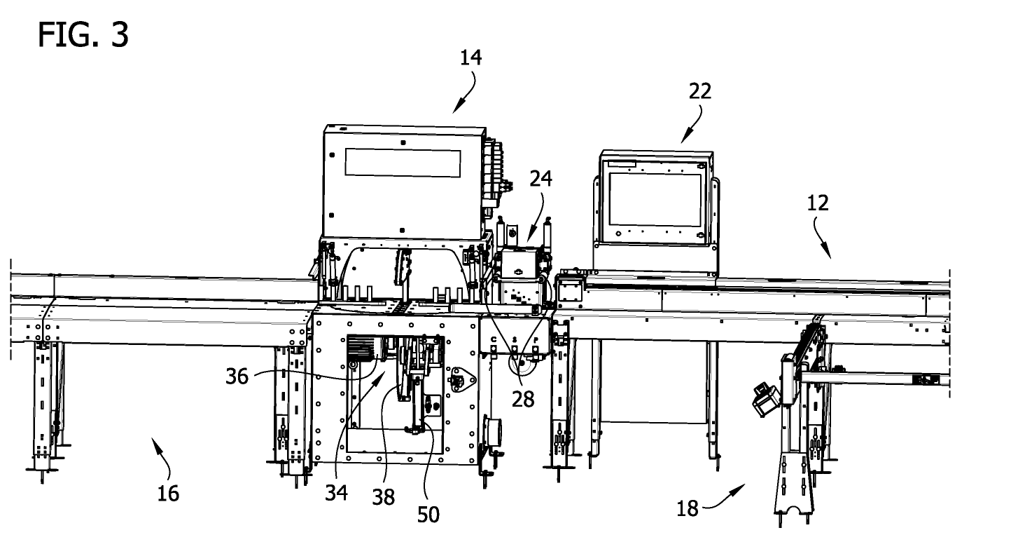

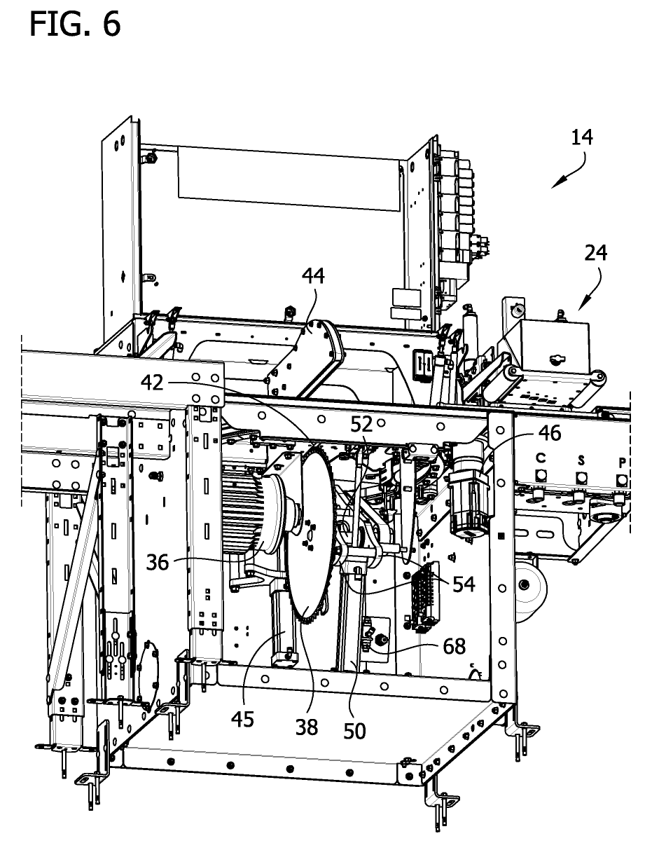

As shown in FIGS. 1-4, the saw unit 14 comprises a housing 32 that contains a saw 34 and also contains saw dust and debris from the cutting operations. The saw 34 includes a motor 36 and a blade 38 indirectly connected to the motor for being driven in rotation by the motor. The connection of the motor 36 to the saw blade 38 is such that the blade may be raised and lowered while the motor remains stationary. The motor 36 and movable blade 38 are mounted on a turntable 40 supported by the housing 32 for rotation in a horizontal plane with respect to the housing 32 to change the cutting angle of the blade 38. The turntable includes a slot 42 through which the blade 38 can project for cutting boards extending across the slot. A holdown 44 positioned above the slot 42 is movable down to engage a board or boards being cut by the blade 38. Movement of the holdown 44 is driven by a pneumatic cylinder 45 (FIG. 6). The holdown 44 presses the boards against the turntable 40 to hold them securely while the cut is being made. The holdown 44 is roughly semi-circular in shape and defines a cavity that can receive a portion of the blade 38 that projects above the boards when cut to cover the blade. The holdown 44 is mounted for rotation with the turntable 40 so that it is always aligned over the slot 42.

Rotation of the turntable 40 is driven by a servo motor 46 supported by the housing 32. In the illustrated embodiment, the turntable 40 is movable in rotation through an angle of about 1400, or about + 700 from the 00 position that is illustrated in the drawings. It will be understood that other angular ranges of motion are possible, but the foregoing range is suitable for making the cuts required to, for example, cut the components of a wood wall frame. Hard, mechanical stops (not shown) prevent the turntable 40 from rotating beyond the limits of the range.

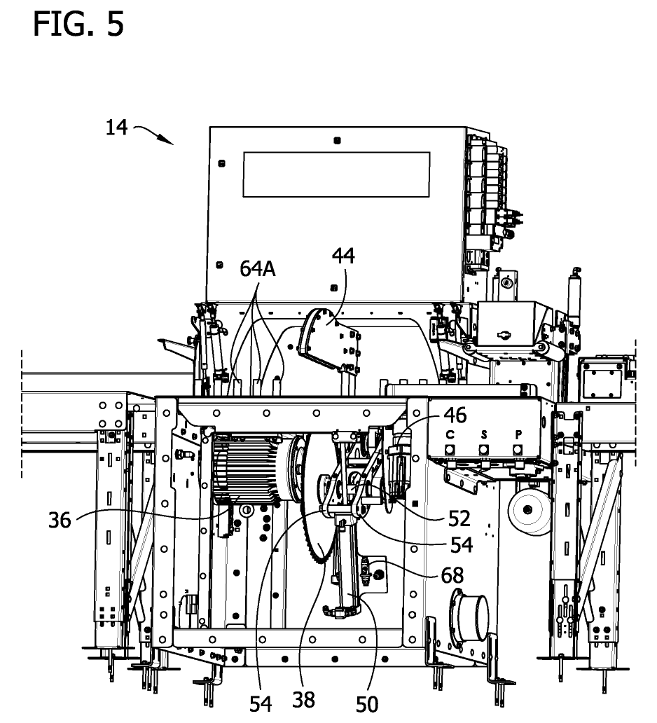

Referring to FIGS. 5 and 6, movement of the saw blade 38 into and out of the slot 42 for cutting boards is driven by a pneumatic cylinder 50. The saw blade 38 and particularly a shaft 52 of the saw blade is mounted between a pair of arms 54. The arms are pivotably mounted on the housing 32 at the rear. The cylinder 50 is operable to pivot the arms 54 upward, thereby moving the blade 38 upward through the slot 42 for cutting the boards. The cylinder 50 may also pivot the arms downward to withdraw the blade 38 from the slot 42.

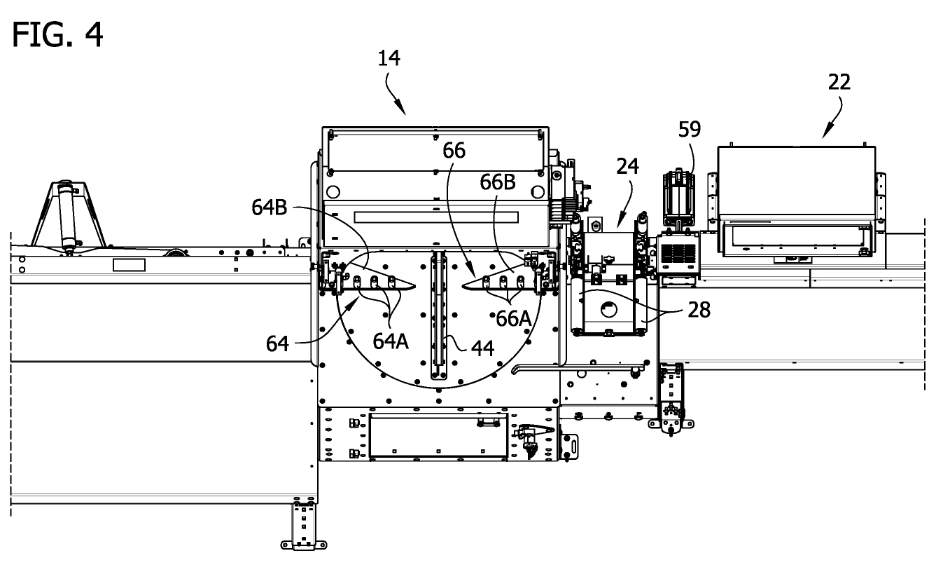

The boards are fed into the saw unit 14 automatically using a pusher bar 58 mounted on a track 60. The pusher bar 58 is driven by a servo motor 59 (FIG. 4) for travel along the track 60 over essentially the entire length of the infeed conveyor 12. The servo motor 59 drives a belt (not shown) to which the pusher bar 58 is attached. The pusher bar is long enough to extend into the saw unit 14 for advancing one or more boards entirely through the saw unit. Boards on the lateral conveyor 18 can be fed laterally onto the infeed conveyor 12. An end of the board can be engaged with the leading end of the pusher bar 58. Depending upon the lengths of the boards being processed, the pusher bar 58 will be positioned for engaging an end of the particular length of board. Thus, the pusher bar 58 pushes the board endwise along the infeed conveyor 12 and into the saw unit 14.

In the saw unit 14, the boards are positioned against a fence comprising a first fence member 64 and a second fence member 66 (FIG. 4). Each of the first and second fence members includes posts 64A, 66A mounted on generally triangular plates 64B, 66B. The triangular plates support the posts 64A, 66A off the turntable 40. Thus, the first and second fence members 64, 66 provide a constant guide path for the boards as they travel through the saw unit 14, regardless of the position of the turntable 40.

In order for the saw system 10 to accurately manufacture many wall frames, it is necessary to calibrate the position of the pusher bar 58 and also the rotation of the turntable 40. These steps may be carried out automatically by initiating an automatic calibration sequence of the controller 20 of the saw system. For example, the automatic calibration can be started by touching a virtual button the monitor in the monitor station 22. In the illustrated embodiment the rotation of the turntable will be calibrated and then the position of the pusher bar will be calibrated. However, the order of calibration can be other than described. A lumber discharge point can also be determined automatically. Calibration can be carried out when the saw system 10 is being set up for initial operation or after maintenance has been performed. In addition, calibration can be carried out after so many hours of operation, when the blade 38 is changed, or at other suitable times and conditions.

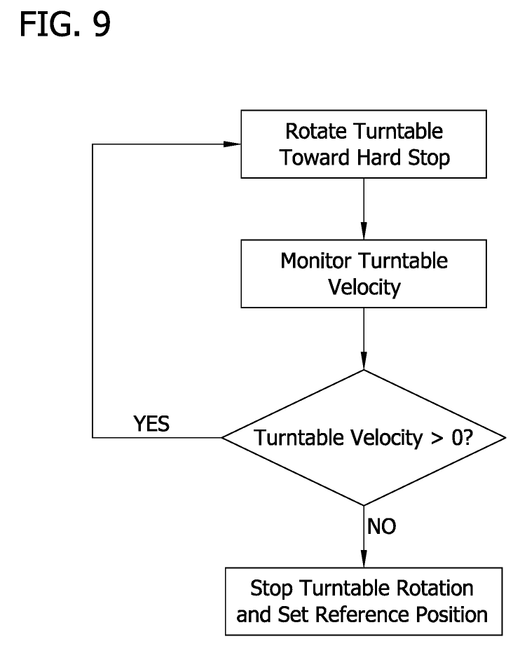

Referring to FIG. 9, to calibrate the rotation of the turntable 40, the servo motor 46 is activated to rotate the turntable in either of the two directions. Rotation continues until the hard stop is detected by the motor 46. In this case, the motor detects that the velocity of the turntable 40 goes to zero when the turntable engages the hard stop limits. Other ways of detecting the turntable 40 has reached the hard stop may be used. Once the hard stop is located through detection of the velocity of the turntable 40 going to zero, the position of the turntable 40 at the hard stop is established as a reference for turntable rotations. The turntable 40 is then rotated (e.g., approximately 700) to the home or 00 position. For example, this position is perpendicular to the path of the boards through the saw unit 14 for cutting the boards and right angles. From this position, the turntable 40 can be rotated in either direction to make angled cuts in the boards.

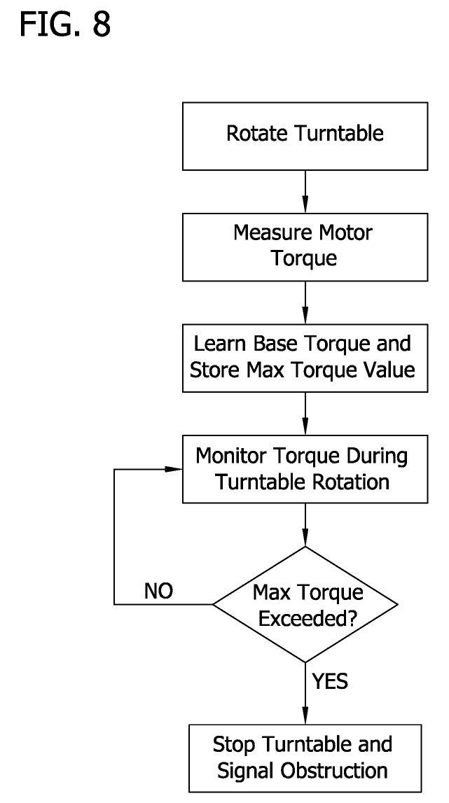

In addition, the saw system 10 is capable of automatically protecting the turntable motor 46 and saw unit 14 from being damaged in operation. Referring to FIG. 8, the saw system 10 can automatically calibrate itself to distinguish between sawdust and debris, and substantial obstructions which could damage the saw unit 14 if the turntable 40 rotation is not stopped. To set up this protection, first the torque required to move the turntable 40 (e.g., the torque that is required to overcome inertia of the turntable and inherent resistance to motion of the turntable ("base motor torque")) is determined. The software of the controller 20 learns the base motor torque by monitoring the measured motor torque as the turntable 40 rotates without engaging any obstruction. This learned base motor torque is then augmented by a small multiplier to establish an operational or maximum torque. In one example, the multiplier is about 1.015, although other values could be used. In operation, the torque on the motor 46, it is possible to distinguish contact of the turntable 40 with a substantial obstruction from another minor obstruction such as saw dust or debris without damaging the machine. Torque at the motor is monitored during movement of the turntable 40. If the measured torque exceeds the operational torque (or in some cases equals the operational torque), the motor 46 is stopped and a signal is sent to the controller that a hard obstruction has been engaged. Monitoring the motor torque may also be used to determine when the turntable 40 has engaged the hard stop (e.g., by exceeding the operational or maximum torque). Thus, motor torque monitoring can also be used to calibrate the reference frame for the turntable rotation.

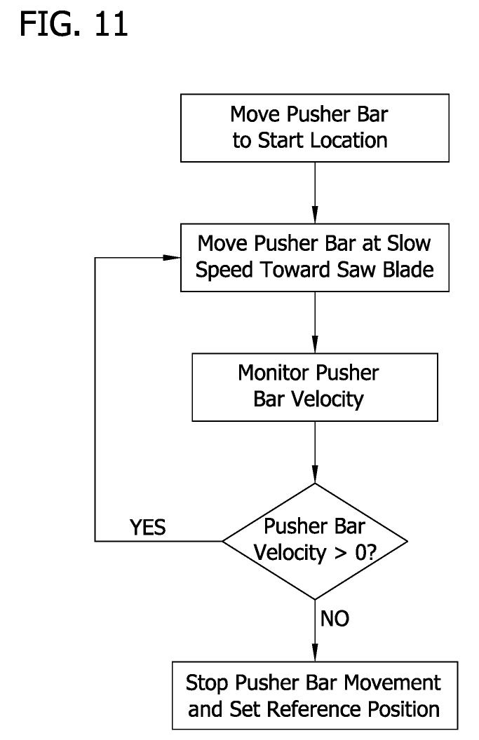

The reference frame for pusher bar 58 motion can also be automatically calibrated. Referring to FIG. 11, initially the pusher bar 58 is rapidly moved to a start location, using a proximity detector (e.g., a visual sensor). Once the pusher bar 58 is moved to the starting position, the controller 20 will change the speed of movement of the pusher bar to a slow setting. Calibration of the pusher bar 58 location continues by activating the cylinder 50, causing the blade 38 to be moved through the slot 42 to that it projects above the turntable 40. The blade 38 is not rotating during the calibration sequence, and is positioned perpendicular to the direction of travel of the pusher bar 58. The pusher bar 58 is then moved by the servo motor 59 at the slow speed from the start location and its velocity is monitored at the motor. Contact of the pusher bar 58 with the blade 38 will be detected by the controller 20 because the servo motor 59 will indicate that that the pusher bar 58 has no velocity. The "no velocity" indication establishes the position of the pusher bar 58 when it touches the blade 38, and this information is stored as a zero reference. The home position for the pusher bar is then determined by using information from the machine settings, which tells the controller 20 the length of the infeed conveyor 12. The blade 38 is then lowered safely back into the housing 32. Other ways of determining that the pusher bar 58 has engaged the blade 38 may be used.

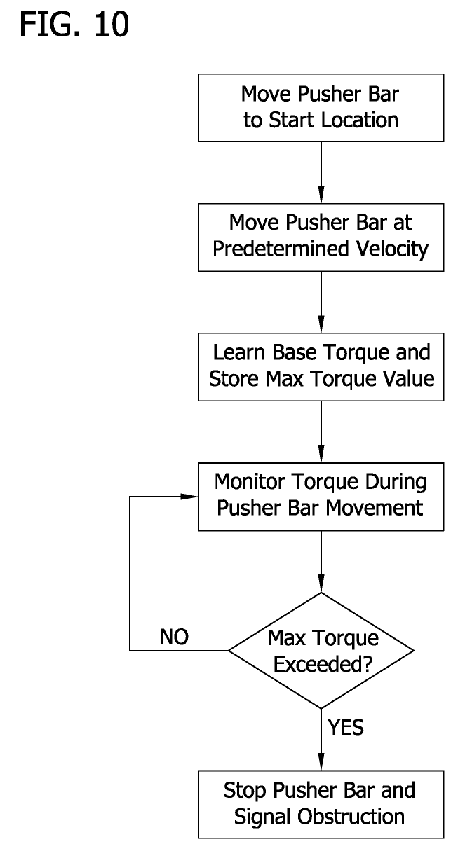

Referring now to FIG. 10, the saw system 10 is able to provide automatic protection against damage to the saw system for the movement of the pusher bar 58. Similar to what was done with the turntable 40, the controller 20 will determine a base pusher bar torque needed to move the pusher bar 58. This is done by measuring the torque at the motor 59 required to overcome the inertia of the pusher bar 58 and its natural resistance to continued motion at the same (slow) speed. This base pusher bar torque value then has a small multiplier applied to it to establish an operational or maximum torque that helps to make sure that no damage is done to the saw system 10 by movement of the pusher bar. In one example, the multiplier is about 1.015. The operational torque distinguishes between minor obstructions such as sawdust and debris and major obstructions that could result in damage to the saw unit 14. The motor torque is monitored as the pusher bar 58 moves. If the detected torque exceeds (or in some cases equals) the operational torque, the motor 59 and pusher bar 58 are stopped. A signal is sent to the controller 20 that a hard obstruction has been engaged. It will be understood that detection of contact of the pusher bar 58 with the blade 38 can be determined by detecting that the motor torque has exceeded the operational or maximum torque during calibration.

A board discharge position of the pusher bar 58 may also be established by an automatic calibration function. This may be done by detecting that a certain point on the pusher bar 58 has reached a proximity sensor positioned roughly at the printer 24. This position is also stored by the calibration routine as the position of the pusher bar 58 which ejects the board from the saw unit 14.

It has been found that by using automated calibration according to the present invention that the time taken to calibrate the saw system 10 has been reduced by 70% to 80% as compared to manual calibration. No particular training or expertise is required by the operator. In addition, the accuracy of the saw system is at least about + 1/32 inch (+ 0.79 mm). Accuracy at this level results in no deviation from manufactured precision requirements for the components formed by the saw system 10. Human error innate to manual calibration is removed.

The saw 34 of the saw system 10 is also able to automatically control the rate at which the blade 38 move into the boards for cutting. ("plunge speed"). The controller 20 calculates a cut profile length necessary for the blade 38 to cut completely through the board. In some instances, this may be a single board, but in other instances boards may be stacked for cutting. The larger the cut profile, the slower the blade 38 needs to move through the board(s) to make a quality cut and avoid unnecessary strain on the blade and the motor 36. In order to make the calculation, the stack height of the board(s), the board width and the cut angle are input into the controller 20. This information can be manually input, but desirably comes from the software that specifies the components of the item that will be built from the sawn boards from the saw system 10. In addition, two constants are provided, the diameter of the blade 38 and the offset of the fence (64, 66) from the saw blade. The offset of the fence 64, 66 is the distance that a plane of the fence is spaced apart from the center of the saw blade 38. It is also envisioned that the height ofthe board(s) could be measured by the saw system 10 rather than being input. In addition, the software could receive information about the type of material being cut to further refine plunge speed. Stated more generally, the software receives "parameters" regarding the material to be cut.

Referring to FIG. 10, the calculation can proceed as follows. A negative angle is determined from the arcsine of the ratio of fence offset to blade radius. A maximum positive cut length is calculated as the square root of the product of the stack height and the difference of the blade diameter and the stack height. A theoretical positive cut length is determined by subtracting the fence offset from the ratio of the board width to the cosine of the cut angle. An actual positive cut length is taken as the lesser of the maximum positive cut length and the theoretical positive cut. A positive angle is calculated as the arctangent of the ratio of the actual positive cut to the difference between the blade radius and the board height. An overall angle is the sum of the positive angle and the negative angle. Finally, a cut profile length is determined as the product of the overall angle and the blade radius. The cut profile length so calculated will be used to set the rate (e.g., via linear interpolation between known minimum and maximum plunge speed rates) at which the blade 38 will be moved up through the board(s) over the slot 42.

It is also envisioned that the controller 20 could receive feedback during the cutting operation to dynamically adjust the plunge speed. For example, the torque on the saw motor 36 could be measured to determine if additional resistance to cutting was being encountered. If so, the plunge speed could be further reduced. On the other hand, if a lesser torque was measured, the plunge speed could be increased to cut more quickly.

As previously described, the movement of the blade 38 through the slot 42 is driven by the pneumatic cylinder 50. The rate at which the pneumatic cylinder moves the blade 38 can be controlled by regulating the backpressure on the exhaust from the pneumatic cylinder 50. A higher backpressure results in a slower rate of advance of the saw blade 38 and a lower backpressure results in a faster rate of advance. Accordingly, a digitally controlled pressure regulator controls a pinch valve 68 on the exhaust of the pneumatic cylinder 50 to regulate back pressure. Other suitable ways of controlling the plunge rate of the blade 38 may be used within the scope of the present invention.

Although described in connection with an exemplary computing system environment, embodiments of the aspects of the disclosure are operational with numerous other general purpose or special purpose computing system environments or configurations. The computing system environment is not intended to suggest any limitation as to the scope of use or functionality of any aspect of the disclosure. Moreover, the computing system environment should not be interpreted as having any dependency or requirement relating to any one or combination of components illustrated in the exemplary operating environment. Examples of well-known computing systems, environments, and/or configurations that may be suitable for use with aspects of the disclosure include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the aspects of the disclosure may be described in the general context of data and/or processor-executable instructions, such as program modules, stored one or more tangible, non-transitory storage media and executed by one or more processors or other devices. Generally, program modules include, but are not limited to, routines, programs, objects, components, and data structures that perform particular tasks or implement particular abstract data types. Aspects of the disclosure may also be practiced in distributed computing environments where tasks are performed by remote processing devices that are linked through a communications network. In a distributed computing environment, program modules may be located in both local and remote storage media including memory storage devices.

In operation, processors, computers and/or servers may execute the processor- executable instructions (e.g., software, firmware, and/or hardware) such as those illustrated herein to implement aspects of the disclosure.

Embodiments of the aspects of the disclosure may be implemented with processor- executable instructions. The processor-executable instructions may be organized into one or more processor-executable components or modules on a tangible processor readable storage medium. Aspects of the disclosure may be implemented with any number and organization of such components or modules. For example, aspects of the disclosure are not limited to the specific processor-executable instructions or the specific components or modules illustrated in the figures and described herein. Other embodiments of the aspects of the disclosure may include different processor-executable instructions or components having more or less functionality than illustrated and described herein.

The order of execution or performance of the operations in embodiments of the aspects of the disclosure illustrated and described herein is not essential, unless otherwise specified. That is, the operations may be performed in any order, unless otherwise specified, and embodiments of the aspects of the disclosure may include additional or fewer operations than those disclosed herein. For example, it is contemplated that executing or performing a particular operation before, contemporaneously with, or after another operation is within the scope of aspects of the disclosure.

Having described the invention in detail, it will be apparent that modifications and variations are possible without departing from the scope of the invention defined in the appended claims.

When introducing elements of the present invention or the preferred embodiment(s) thereof, the articles "a", "an", "the" and "said" are intended to mean that there are one or more of the elements. The terms "comprising", "including" and "having" are intended to be inclusive and mean that there may be additional elements other than the listed elements.

In view of the above, it will be seen that the several objects of the invention are achieved and other advantageous results attained.

As various changes could be made in the above products without departing from the scope of the invention, it is intended that all matter contained in the above description and shown in the accompanying drawings shall be interpreted as illustrative and not in a limiting sense.

What is claimed is:

1. A dynamically adjustable automated saw system comprising:
a saw for automated cutting of material, the saw having a saw blade configured to plunge into the material during the cutting;
a controller in communication with the saw for controlling operation of the saw;
a memory storing processor-executable instructions that, when executed, configure the controller for:receiving one or more parameters of the material to be cut;determining a cut profile length as a function of the received one or more parameters; anddynamically adjusting a rate at which the saw blade plunges into the material to be cut based on the determined cut profile length.

2. The system of claim 1, wherein the at least one of the parameters is selected from the group consisting of: material width, material height, cut angle, saw blade diameter, and saw fence offset.

3. The system of claim 1, further comprising a pneumatic cylinder configured to plunge the saw blade into the material to be cut.

4. The system of claim 3, further comprising a digitally controlled pressure regulator coupled to the pneumatic cylinder, the pressure regulator responsive to the controller for controlling the pneumatic cylinder to dynamically adjust the rate at which the saw blade plunges into the material.

5. The system of claim 4, wherein the pressure regulator comprises a pinch valve in fluid communication with the pneumatic cylinder, the pinch valve configured to restrict gas flow on an exhaust side of the pneumatic cylinder.

6. The system of claim 1, further comprising a torque sensor configured to measure torque on the saw blade during cutting and wherein dynamically adjusting the rate at which the saw blade plunges into the material is further based on the measured torque.

7. A method of automated cutting of material comprising:
receiving one or more parameters of a material to be cut by a saw blade, the saw blade configured to plunge into the material during cutting;
executing processor-executable instructions to determine a cut profile length of the material to be cut as a function of the received one or more parameters;
plunging the saw blade into the material during cutting; and
dynamically adjusting a rate at which the saw blade plunges into the material to be cut based on the determined cut profile length.

8. The method of claim 7, wherein the at least one of the parameters is selected from the group consisting of: material width, material height, stack height, cut angle, saw blade diameter, and saw fence offset.

9. The method of claim 7, wherein a pneumatic cylinder is configured to plunge the saw blade into the material during cutting and wherein dynamically adjusting the rate at which the saw blade plunges into the material to be cut comprises controlling the pneumatic cylinder by a digitally controlled pressure regulator coupled thereto.

10. The method of claim 9, wherein controlling the pneumatic cylinder comprises adjusting a pinch valve in fluid communication with the pneumatic cylinder to restrict gas flow on an exhaust side of the pneumatic cylinder.

11. The method of claim 7, further comprising measuring torque on the saw blade during cutting and wherein dynamically adjusting the rate at which the saw blade plunges into the material is further based on the measured torque.
